(19) United States
(12) Patent Application Publication
(10) Pub. No.: US 2015/0037671 A1
(43) Pub. Date: Feb. 5, 2015

(54) NEGATIVE ELECTRODE FOR LITHIUM SECONDARY BATTERY AND METHOD FOR MANUFACTURING THE SAME

(71) Applicant: NEC Corporation, Tokyo (JP)

(72) Inventors: Jiro Iriyama, Tokyo (JP); Tetsuya Kajita, Tokyo (JP)

(21) Appl. No.: 14/378,510

(22) PCT Filed: Oct. 16, 2012
(86) PCT No.: PCT/JP2012/076706

§ 371 Date: Aug. 13, 2014

(30) Foreign Application Priority Data
Feb. 13, 2012 (JP) 2012-028147

(51) Int. Cl. H01M 4/62; H01M 4/04; H01M 10/058; H01M 10/052

(52) U.S. Cl. CPC H01M 4/622; H01M 10/052; H01M 4/0471; H01M 10/058
USPC 429/217; 429/212; 29/623.1

(57) ABSTRACT

It is an object of the exemplary embodiment of the present invention to provide a method for manufacturing a negative electrode for a lithium secondary battery by which conductive metal particles can be uniformly and easily formed in a conductive intermediate layer. The exemplary embodiment of the present invention is a method for manufacturing a negative electrode for a lithium secondary battery comprising a current collector comprising a metal, an active material layer comprising an active material and a binding agent, and a conductive intermediate layer comprising conductive metal particles between the current collector and the active material layer, comprising steps of (1) placing a polyamic acid on the current collector; (2) causing the metal to move from the current collector into the polyamic acid by generating migration phenomenon; and (3) heating and curing the polyamic acid, in this order, wherein the metal that has moved into the polyamic acid forms the conductive metal particles.

### TECHNICAL FIELD

The present invention relates to a negative electrode used in a lithium secondary battery, and a method for manufacturing the same.

### BACKGROUND ART

As negative electrodes for lithium secondary batteries, various ones have been proposed so far.

For example, Patent Literature 1 discloses a secondary battery comprising an active material layer on a current collector and comprising an active material and a modified organometallic complex in the active material layer. In the technique in Patent Literature 1, after applying a binder resin comprising an organometallic complex, heat treatment is performed to eliminate the organic substance of the organometallic complex to form a modified organometallic complex in an active material layer.

Patent Literature 2 discloses a method for forming the negative electrode of a lithium ion battery which includes the steps of depositing a slurry of an electrode composition comprising electrochemically active particles, metallic conductive diluting particles not electrochemically active, and nonmetallic conductive diluting particles on a current collector, and performing heat treatment. As examples of the metallic conductive diluent particles, copper, iron, nickel, and titanium are disclosed.

Patent Literature 3 discloses a lithium secondary battery in which an adhesive layer is provided between a negative electrode active material layer and a negative electrode current collector, and in which the binding agent included in the negative electrode active material layer and the adhesive layer comprises a modified fluorine-containing polymer compound.

Patent Literature 4 discloses a method for forming a negative electrode for a lithium secondary battery in which a conductive intermediate layer comprising conductive particles is placed between a mixture layer comprising active material particles and a current collector. In the method in Patent Literature 4, the negative electrode is formed by first depositing the conductive intermediate layer and the mixture layer on the current collector and then performing heat treatment. As examples of the conductive particles, conductive metal particles and conductive carbon particles are disclosed. As examples of the conductive metal particles, copper, nickel, iron, and titanium are disclosed.

### CITATION LIST

### Patent Literature

### Patent Literature 1: JP2011-065812A

### Patent Literature 2: JP2009-538513A

### Patent Literature 3: JP2004-200011A

### Patent Literature 4: JP2004-288520A

### SUMMARY OF INVENTION

### Technical Problem

Here, an advantage of providing an adhesive layer or a conductive intermediate layer between an active material layer and a current collector as shown in Patent Literatures 3 and 4 is that the cycle characteristics and rate characteristics of the battery are improved. However, in Patent Literatures 3 and 4, the adhesive layer or the conductive intermediate layer is formed using a slurry comprising particles, and in this case, the dispersibility and uniformity of the particles in the slurry may be problems. For example, particles settle during preparation of the slurry, and dispersibility of the slurry may decrease. In addition, complicatedness, problems, and the like in handling the particles themselves or the slurry comprising the particles also occur. Further, when the average particle diameter of the particles is 1 μm or less, the specific surface area of the particles increases, and therefore, the surfaces of the particles are easily oxidized. As a result, conductivity may decrease.

### Solution to Problem

The exemplary embodiment of the present invention is

a negative electrode for a lithium secondary battery comprising a current collector comprising a metal, and an active material layer comprising an active material and a binding agent, wherein,

the negative electrode has a conductive intermediate layer comprising conductive metal particles comprising the same element as the metal, and a polyimide or polyamideimide, between the current collector and the active material layer, and

a content of the conductive metal particles in the conductive intermediate layer is 23% by volume or more and 70% by volume or less.

In addition, the exemplary embodiment of the present invention is

a method for manufacturing a negative electrode for a lithium secondary battery comprising a current collector comprising a metal, an active material layer comprising an active material and a binding agent, and a conductive intermediate layer comprising conductive metal particles between the current collector and the active material layer, comprising steps of:

(1) placing a polyamic acid on the current collector;

(2) causing the metal to move from the current collector into the polyamic acid by generating migration phenomenon; and

(3) heating and curing the polyamic acid, in this order, wherein

the metal that has moved into the polyamic acid forms the conductive metal particles.

### Advantageous Effects of Invention

The exemplary embodiment of the present invention can provide a negative electrode for a lithium secondary battery which has excellent discharge characteristics.

In addition, the exemplary embodiment of the present invention can provide a method for manufacturing a negative electrode for a lithium secondary battery in which conductive metal particles can be more uniformly and easily formed in the conductive intermediate layer.

### BRIEF DESCRIPTION OF DRAWINGS

FIG. 1 is a schematic diagram showing an example of the configuration of a negative electrode according to the exemplary embodiment of the present invention.

FIG. 2 is a schematic cross-sectional view showing the structure of the electrode device of a laminate type secondary battery.

FIG. 3 is a diagram showing the results of Examples, Comparative Examples, and Reference Examples.

### DESCRIPTION OF EMBODIMENTS

### Exemplary Embodiment 1

The present inventors have studied diligently and discovered that a metal included in a current collector can be moved into a polyamic acid utilizing migration phenomenon, arriving at the present invention.

As described above, a manufacturing method in the exemplary embodiment of the present invention is

a method for manufacturing a negative electrode for a lithium secondary battery comprising a current collector comprising a metal, an active material layer comprising an active material and a binding agent, and a conductive intermediate layer comprising conductive metal particles between the current collector and the active material layer, comprising the steps of:

(1) placing a polyamic acid on the current collector;

(2) causing the metal to move from the current collector into the polyamic acid by generating migration phenomenon; and

(3) heating and curing the polyamic acid, in this order, wherein

the metal that has moved into the polyamic acid forms the conductive metal particles.

In the manufacturing method in the exemplary embodiment of the present invention, first, a polyamic acid is placed on a current collector. The metal used for the current collector dissolves in a polyamic acid having a carboxyl group that is an acidic group. The metal included in the current collector is not particularly limited. Examples thereof include copper, nickel, gold, or silver. The metal is preferably copper, nickel, or silver, more preferably copper or nickel, and further preferably copper. Therefore, the current collector preferably comprises at least one selected from copper, nickel, and silver. It is known that various metals used for current collectors are corroded by a polyamic acid having a carboxyl group (for example, Patent Literatures JP2009-019132A and JP2005-010360A). In other words, it is known that a metal used for a current collector dissolves in a polyamic acid. The metal may dissolve in a polyamic acid and, as a result, form a complex.

Next, migration phenomenon causes the above metal to move from the current collector into the polyamic acid. Migration phenomenon herein means a phenomenon in which a metal in a solid phase becomes an ion and moves to another phase. “generating migration phenomenon” includes meaning “promoting migration”.

Next, the polyamic acid is cured to form a polyimide or polyamideimide.

According to the above steps, a conductive intermediate layer in which conductive metal particles are included in a polyimide or a polyamideimide can be formed.

In this manner, in the exemplary embodiment of the present invention, the metal included in the current collector can be moved into the polyamic acid by utilizing migration phenomenon. The metal that has moved into the polyamic acid is then deposited to form conductive metal particles. It is considered that in the exemplary embodiment of the present invention, by promoting the movement and diffusion of the metal included in the current collector into the polyamic acid by migration phenomenon, the conductive metal particles can be formed in the conductive intermediate layer. Therefore, in the exemplary embodiment of the present invention, it is not necessary to handle particles, and the complicatedness and problem of handling particles or a slurry comprising particles are eliminated. In addition, by forming the conductive metal particles utilizing migration phenomenon, the conductive metal particles can be more uniformly formed in the conductive intermediate layer, and the rate characteristics of the battery can be improved. Further, in the exemplary embodiment of the present invention, the conductive metal particles are formed in the conductive intermediate layer without contact with a gas phase, and therefore, the oxidation of the surfaces of the conductive metal particles can be suppressed.

The migration phenomenon is preferably caused by coating the current collector with a polyamic acid and then performing heat treatment under a condition in which the temperature is lower than the imidization temperature of the polyamic acid. By performing heat treatment under a condition in which the temperature is lower than the imidization temperature, that is, at a temperature at which the polyamic acid is not cured, the dissolution of the metal included in the current collector into the polyamic acid is promoted. The temperature of the heat treatment is not particularly limited as long as migration phenomenon occurs. The temperature of the heat treatment is, for example, 80° C. or more, preferably 90° C. or more, and more preferably 100° C. or more. Further, the temperature of the heat treatment is preferably in the range of 80 to 150° C.

It is considered that the metal that has moved into the polyamic acid by migration phenomenon is also deposited under heating conditions. The metal may be further deposited by heat dissipation after the heat treatment.

The duration of the heat treatment is preferably 8 hours or more though depending on conditions, such as heating temperature.

By adding an organic acid to the polyamic acid in the above heat treatment, migration phenomenon can be further promoted. Examples of the organic acid include phthalic acid, oxalic acid, or maleic acid. By adding the organic acid to the polyamic acid, the metal included in the current collector dissolves easily in the polyamic acid.

The content of the conductive metal particles obtained in the exemplary embodiment of the present invention is not particularly limited and is preferably 23% by volume or more and 70% by volume or less in the conductive intermediate layer. When the content of the conductive metal particles is in this range, a negative electrode that has excellent discharge characteristics under large current can be obtained, as described later. The content of the conductive metal particles is more preferably 26% by volume or more and 50% by volume or less in the conductive intermediate layer. The content of the conductive metal particles can be controlled by the conditions of migration phenomenon and can be controlled, for example, by heat-temperature and heat-time. The higher the heating temperature, and the longer the heating time, the higher is the content.

The average particle diameter (D₅₀, volume basis) of the conductive metal particles obtained in the exemplary embodiment of the present invention is, for example, 50 nm or less, preferably 1 nm or more and 30 nm or less, and more preferably 5 nm or more and 25 nm or less. By depositing conductive metal particles utilizing migration phenomenon as in the exemplary embodiment of the present invention, fine particles having a small average particle diameter can be more uniformly formed in the conductive intermediate layer.

The metal included in the current collector is preferably a metal that does not form an alloy with Li as described above. Examples of such a metal include copper, nickel, gold, or silver. In the present specification, “not forming an alloy with Li” refers to “not forming an alloy in the environment of a secondary battery”, and refers to, for example, “not forming an alloy with Li in the potential range of 0 to 4.5 V (Li/Li⁺)”. The temperature at this time is, for example, −20 to 60° C.

Whether or not a metal can be dissolved in the polyamic acid can be determined, for example, by confirming the coordinate bond between the carboxylic acid group of the polyamic acid and the metal by spectroscopic analysis, such as visible and ultraviolet absorption, infrared absorption, and Raman.

The negative electrode can be fabricated, for example, by forming the above conductive intermediate layer on a current collector and then forming an active material layer comprising an active material and a binding agent.

Alternatively, the negative electrode can also be fabricated by placing a polyamic acid on a current collector and generating migration phenomenon, and then placing an active material layer slurry on the polyamic acid and performing heating and curing. By using a polyamic acid as the precursor of the binding agent at this time, crosslinks are formed between the binding agent and the active material layer, and the binding force can be improved. From the viewpoint of more effectively forming crosslinks, the polyamic acid used for the conductive intermediate layer and the polyamic acid used for the binding agent of the active material layer are preferably the same.

Examples of the method for forming the active material layer include a doctor blade method, a die coater method, a CVD method, and a sputtering method.

### Exemplary Embodiment 2

As described above, in the manufacturing method in the exemplary embodiment of the present invention, the conductive metal particles can be uniformly formed in the conductive intermediate layer. In addition, even if the content of the conductive metal particles in the conductive intermediate layer is high content, fine particles can be more uniformly formed without causing problems in the handling of particles, such as aggregation. The present inventors have manufactured negative electrodes for lithium secondary batteries comprising a conductive intermediate layer between a current collector and an active material layer, using the manufacturing method in the exemplary embodiment of the present invention, and discovered that when the content of the conductive metal particles in the conductive intermediate layer is 23% by volume or more and 70% by volume or less, a negative electrode that has excellent discharge characteristics under large current can be obtained.

In other words, a negative electrode for a lithium secondary battery in the exemplary embodiment of the present invention is

a negative electrode for a lithium secondary battery comprising a current collector comprising a metal, and an active material layer comprising an active material and a binding agent, wherein,

the negative electrode comprises a conductive intermediate layer comprising: conductive metal particles comprising the same element as the metal, and a polyimide or polyamideimide, between the current collector and the active material layer, and

the content of the conductive metal particles in the conductive intermediate layer is 23% by volume or more and 70% by volume or less.

The components of the negative electrode for a lithium secondary battery in the exemplary embodiment of the present invention will be described in detail below.

(Negative Electrode)

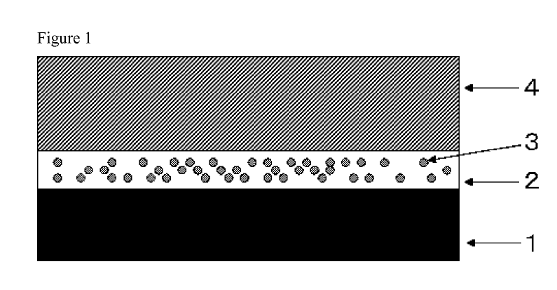

The negative electrode for a lithium secondary battery in the exemplary embodiment of the present invention comprises a current collector and an active material layer and comprises a conductive intermediate layer between the current collector and the active material layer as shown in FIG. 1. It is preferred that the current collector and the conductive intermediate layer be in direct contact with each other, and that the active material layer and the conductive intermediate layer be in direct contact with each other.

<Conductive Intermediate Layer>

The conductive intermediate layer has a configuration in which conductive metal particles comprising the same element as the metal included in the current collector are included in a polyimide or polyamideimide.

The content of the conductive metal particles in the conductive intermediate layer is 23% by volume or more and 70% by volume or less. The content of the conductive metal particles in the conductive intermediate layer is preferably 26% by volume or more and 50% by volume or less, more preferably 26.6% by volume or more and 38.7% by volume or less.

The average particle diameter (D₅₀, volume basis) of the conductive metal particles is preferably 50 nm or less, preferably larger than 0 and 50 nm or less, more preferably 1 nm or more and 30 nm or less, and further preferably 5 nm or more and 25 nm or less.

For example, when the metal forming the conductive metal particles is copper, the weight ratio corresponding to a content of 23% by volume or more and 50% by volume or less is about 67% by weight or more and 87% by weight or less.

The conductive intermediate layer is preferably formed using the manufacturing method in the exemplary embodiment of the present invention from the viewpoint of the uniformity of the fine particles. For example, the conductive intermediate layer can be formed as follows. First, a current collector comprising copper (for example, copper foil) is coated with a polyamic acid having a carboxyl group and then heated under a condition (for example, 80 to 150° C.) lower than a temperature at which the polyamic acid is imidized for 8 to 24 hours to move the copper from the current collector into the polyamic acid. Then, the coated current collector is heated, for example, at 300 to 350° C. to imidize the polyamic acid. This is considered to be that the copper dissolves in the polyamic acid having a carboxyl group, and that heating induces the diffusion of copper ions into the layer, and thus the migration of the copper occurs. The content of the conductive metal particles in the conductive intermediate layer can be controlled, for example, by varying heat-temperature and heat-time. The higher the heating temperature is, the higher the content is. Also, the longer the heating time is, the higher the content is.

The content (% by volume) of the conductive metal particles in the conductive intermediate layer can be obtained, for example, from the true density of the conductive metal and the polyimide and the content (% by weight) of the conductive metal particles in the conductive intermediate layer. The content (% by weight) of the conductive metal particles in the conductive intermediate layer also can be measured, for example, by dynamic secondary ion mass spectrometry (D-SIMS). The average particle diameter (D₅₀, volume basis) of the conductive metal particles in the conductive intermediate layer can be obtained, for example, by subjecting an image obtained by an electron microscope to analysis processing. Examples of the image analysis processing apparatus include LUZEX AP (trade name) manufactured by NIRECO CORPORATION.

The conductive metal particles preferably comprise at least one selected from copper, nickel, gold, and silver.

The temperature at which the polyamic acid is imidized is not particularly limited and is, for example, more than 150° C., preferably 200° C. or more, and more preferably 250° C. or more. In addition, the temperature is preferably 400° C. or less, more preferably 350° C. or less.

The thickness of the conductive intermediate layer is not particularly limited and is, for example, 0.1 to 10 μm, preferably 0.5 to 5 μm.

<Current Collector>

The metal included in the current collector is preferably a metal that does not form an alloy with Li as described above. Examples of the current collector include copper, nickel, gold, and silver, and alloys thereof. The current collector preferably comprises copper, nickel, or silver, and more preferably comprises copper or nickel. Examples of the shape of the current collector include foil, a flat plate shape, and a mesh shape.

As the current collector, foil or mesh comprising copper as the main component is preferably used. For example, the ratio of copper in the current collector is preferably 97 to 100% by mass from the viewpoint of conductivity and heat resistance.

<Active Material Layer>

The active material layer (negative electrode active material layer) comprises an active material (negative electrode active material) and a binding agent (negative electrode binding agent).

The active material is not particularly limited as long as lithium ions can be intercalated during charge and desorbed during discharge. For example, known ones can be used.

Specific examples of the active material include carbon materials, such as graphite, coke, and hard carbon, lithium alloys, such as lithium-aluminum alloys, lithium-lead alloys, and lithium-tin alloys, lithium metal, Si, and metal oxides having lower potential than lithium manganese composite oxides, such as SnO₂, SnO, TiO₂, Nb₂O₃, and SiO.

The active material preferably comprises at least one selected from Si and Sn. Examples of such an active material include Si, Sn, or oxides of Si or Sn. These oxides may be crystalline or amorphous, and it is preferred that all or part of the oxides have an amorphous structure. It is thought that in an oxide having an amorphous structure, there are a relatively small number of factors caused by nonuniformity, such as grain boundaries and defects. The fact that all or part of an oxide has an amorphous structure can be confirmed by X-ray diffraction measurement (general XRD measurement). Specifically, when all or part of an oxide has an amorphous structure, a broad peak specific to the oxide is observed.

Examples of the active material comprising Si include silicon-containing particles shown below. Examples of the silicon-containing particles include silicon and silicon compounds. Examples of the silicon compounds include silicon oxides, silicates, or compounds of transition metals and silicon, such as nickel silicide and cobalt silicide. Silicon compounds play the role of relieving the expansion and shrinkage of the negative electrode active material itself with respect to repeated charge and discharge and are preferably used from the viewpoint of charge and discharge cycle characteristics. Further, silicon compounds also play the role of ensuring conduction between silicons depending on the types of the silicon compounds, and from such a viewpoint, silicon oxides are preferably used as the silicon compounds.

The silicon oxide is not particularly limited and is represented, for example, by SiOₓ (0<x<2). The silicon oxide may comprise Li, and the silicon oxide comprising Li is represented, for example, by SiLi_{y}O_{z} (y>0, and 2>z>0). The silicon oxide also may comprise a slight amount of a metal element(s) and/or a nonmetal element(s). The range of x is preferably 0.5≦x≦1.5. When x is 0.5 or more, the amount of the silicon phase (or Si particles) is prevented from being excessive, and volume change is easily suppressed. When x is 1.5 or less, the amount of the silicon phase (Si particles) increases, and the charge and discharge capacity is easily increased. The silicon oxide preferably has a configuration in which a silicon phase (Si particles) is present in a silicon oxide phase. By comprising a silicon phase, the charge and discharge capacity increases. When a silicon oxide phase is present around a silicon phase, volume change is suppressed. The content of the Si particles in the silicon oxide is preferably 35 to 65%. The silicon oxide can contain, for example, one or two or more elements selected from among nitrogen, boron, and sulfur, for example, in an amount of 0.1 to 5% by mass. By containing a slight amount of a metal element(s) and/or a nonmetal element(s), the electrical conductivity of the silicon oxide can be improved. The silicon oxide may be crystalline or amorphous.

The content of the active material in the active material layer is preferably 40% by mass or more and 99% by mass or less, more preferably 50% by mass or more and 95% by mass or less, and further preferably 65% by mass or more and 90% by mass or less, from the viewpoint of energy density improvement.

The active material layer may comprise a conductivity-providing agent from the viewpoint of improving conductivity. As the conductivity-providing agent, there is no particular limitation, and, for example, known ones can be used. Examples of the conductivity-providing agent include carbon materials. Examples of the carbon materials include graphite, amorphous carbon, diamond-like carbon, carbon black, ketjen black, acetylene black, vapor-grown carbon fibers, fullerenes, carbon nanotubes, and composites thereof. One of these conductivity-providing agents may be used alone, or two or more of these conductivity-providing agents may be used together. Graphite having high crystallinity has high electrical conductivity and has excellent adhesiveness to a current collector comprising a metal, such as copper, and excellent voltage flatness. On the other hand, in amorphous carbon having low crystallinity, the volume expansion is relatively small, and therefore, the effect of reducing the volume expansion of the entire negative electrode is large, and deterioration caused by nonuniformity, such as grain boundaries and defects, does not occur easily.

The content of the conductivity-providing agent in the active material layer is preferably 1% by mass or more and 25% by mass or less, more preferably 2% by mass or more and 20% by mass or less, and further preferably 5% by mass or more and 15% by mass or less. When the content is 1% by mass or more, sufficient conductivity can be kept. By setting the content to 25% by mass or less, the proportion of the mass of the active material can be increased, and therefore, the capacity per mass can be increased.

The binding agent is not particularly limited, and, for example, polyvinylidene fluorides, vinylidene fluoride-hexafluoropropylene copolymers, vinylidene fluoride-tetrafluoroethylene copolymers, styrene-butadiene copolymerized rubbers, polytetrafluoroethylene, polypropylene, polyethylene, polyimides, and polyamideimides can be used. The amount of the negative electrode binding agent used is preferably 7 to 20 parts by mass based on 100 parts by mass of the negative electrode active material from the viewpoint of “sufficient binding force” and “higher energy” in a trade-off relationship.

The binding agent is preferably a polyimide or a polyamideimide from the viewpoint of binding properties to the conductive intermediate layer. As the precursor of the binding agent, a polyamic acid is preferably used, and the same polyamic acid as the polyamic acid used for the conductive intermediate layer is more preferably used.

The negative electrode can be fabricated, for example, by forming the above conductive intermediate layer on a current collector and then forming an active material layer comprising an active material and a binding agent.

Alternatively, the negative electrode can also be fabricated by placing a polyamic acid on a current collector and generating migration phenomenon, and then placing an active material layer slurry on the polyamic acid and performing heating and curing. By using a polyamic acid as the precursor of the binding agent at this time, crosslinks are formed between the binding agent and the active material layer, and the binding force can be improved. From the viewpoint of more effectively forming crosslinks, the polyamic acid used for the conductive intermediate layer and the polyamic acid used for the binding agent of the active material layer are preferably the same.

### Exemplary Embodiment 3

The configuration of a battery will be described below.

(Positive Electrode)

In the exemplary embodiment of the present invention, the positive electrode active material is not particularly limited as long as lithium ions can be intercarated during charge and desorbed during discharge. For example, known ones can be used. The positive electrode active material is preferably a lithium transition metal oxide. The lithium transition metal oxide is not particularly limited. Examples thereof include lithium manganate having a layered structure or lithium manganate having a spinel structure, such as LiMnO₂ or LiₓMn₂O₄ (0<x<2); LiCoO₂, LiNiO₂, or lithium transition metal oxides in which parts of the transition metals of these are replaced by other metals; lithium transition metal oxides in which particular transition metals do not exceed half, such as LiNi_{1/3}Co_{1/3}Mn_{1/3}O₂; lithium transition metal oxides having an olivine structure, such as LiFePO₄; and these lithium transition metal oxides in which Li is more excessive than in stoichiometric compositions. Particularly, LiαNiβCoγAlδO₂ (1≦α≦1.2, β+γ+δ=1, β≧0.7, and γ≦0.2) or LiαNiβCoγMnδO₂ (1≦α≦1.2, β+γ+δ=1, β≧0.6, and γ≦0.2) is preferred. One of these materials can be used alone, or two or more of these materials can be used in combination.

The positive electrode according to the exemplary embodiment of the present invention can also comprise a positive electrode conductivity-providing agent and a positive electrode binding agent in addition to the positive electrode active material.

As the positive electrode conductivity-providing agent, powders of metal substances, such as aluminum, and conductive oxides, and the like can be used in addition to the carbon materials that are used for the above negative electrode conductivity-providing agents.

The positive electrode binding agent is not particularly limited, and, for example, polyvinylidene fluorides, vinylidene fluoride-hexafluoropropylene copolymers, vinylidene fluoride-tetrafluoroethylene copolymers, styrene-butadiene copolymerized rubbers, polytetrafluoroethylene, polypropylene, polyethylene, polyimides, and polyamideimides can be used. Among these, polyvinylidene fluoride (PVdF) is preferred from the viewpoint of versatility and low cost.

The content of the positive electrode binding agent in the positive electrode active material layer is preferably 1% by mass or more and 25% by mass or less, more preferably 2% by mass or more and 20% by mass or less, and further preferably 5% by mass or more and 15% by mass or less. By setting the content to 1% by mass or more, the occurrence of electrode peeling can be prevented. By setting the content to 25% by mass or less, the proportion of the mass of the positive electrode active material can be increased, and therefore, the capacity per mass can be increased.

As the positive electrode current collector, nickel, copper, silver, and aluminum, and alloys thereof are preferred because of electrochemical stability. Examples of its shape include foil, a flat plate shape, and a mesh shape. Particularly, copper foil and aluminum foil are preferred.

A conductive auxiliary material may be added to the positive electrode active material layer comprising the positive electrode active material for the purpose of decreasing impedance. Examples of the conductive auxiliary material include carbonaceous fine particles, such as graphite, carbon black, and acetylene black.

The positive electrode can be fabricated, for example, by mixing a lithium manganese composite oxide, a conductivity-providing agent, and a positive electrode binding agent to prepare a positive electrode slurry, and forming the positive electrode slurry on a positive electrode current collector.

(Electrolyte)

As the electrolyte, for example, liquid-state electrolytes (electrolytic solutions) can be used.

The electrolytic solution used in the exemplary embodiment of the present invention is not particularly limited and comprises, for example, an electrolyte salt and a nonaqueous electrolytic solvent.

The nonaqueous electrolytic solvent is not particularly limited. Examples thereof can include cyclic carbonates, such as propylene carbonate, ethylene carbonate, butylene carbonate, and vinylene carbonate; chain carbonates, such as dimethyl carbonate, diethyl carbonate, ethyl methyl carbonate, and dipropyl carbonate; and lactones, such as γ-butyrolactone, from the viewpoint of being stable at metal lithium potential. One nonaqueous electrolytic solution can be used alone, or two or more nonaqueous electrolytic solutions can be used in combination.

The electrolyte salt is not particularly limited. Examples thereof include lithium salts, such as LiPF₆, LiAsF₆, LiAlCl₄, LiClO₄, LiBF₄, LiSbF₆, LiCF₃SO₃, LiCF₃CO₂, Li(CF₃SO₂)₂, and LiN(CF₃SO₂)₂. One electrolyte salt can be used alone, or two or more electrolyte salts can be used in combination.

As the electrolytic solution, ionic liquids can also be used. Examples of the ionic liquids include quaternary ammonium-imide salts.

Further, solid-state electrolytes rather than liquid-state electrolytes may be used. Examples of the solid-state electrolytes include gel electrolytes obtained by impregnating polymers, such as polyacrylonitrile and polyacrylates, with the above electrolytic solutions, and solid electrolytes, such as LiPON and Li₂S—LiPₓO_{y} (x=1 to 2 and y=2 to 4).

(Separator)

The separator is not particularly limited, and, for example, known separators can be adopted. As the separator, for example, porous films and nonwoven fabrics of polypropylene, polyethylene, and the like can be used. Films of polyimides and aramids, films of cellulose, and the like can also be used.

(Package)

As the package, those that are stable in the electrolytic solution and have sufficient water vapor barrier properties can be used without particular limitation. As the package, for example, cans of metals, such as iron and aluminum alloys, laminate films can be used. The laminate films are preferably laminate films in which aluminum or silica is vapor-deposited from the viewpoint of water vapor barrier properties.

(Configuration of Battery)

The configuration of a secondary battery according to the exemplary embodiment of the present invention is not particularly limited and can be, for example, a configuration in which an electrode device in which a positive electrode and a negative electrode are disposed opposed to each other and an electrolytic solution are included in a package. The shape of the secondary battery is not particularly limited. Examples thereof include a cylindrical type, a flat wound prismatic type, a laminated prismatic type, a coin type, a flat wound laminate type, or a laminate type.

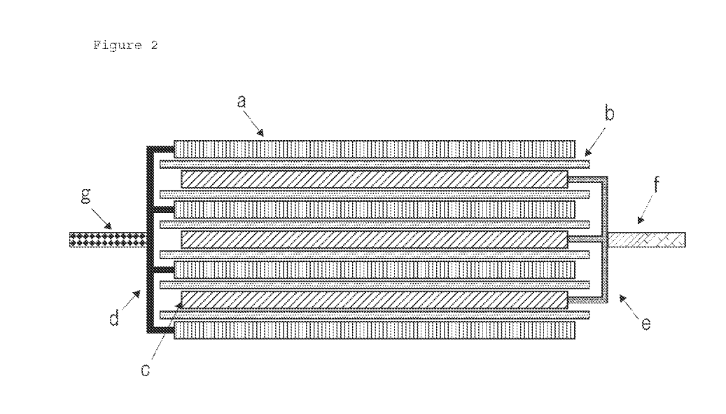

A laminate type secondary battery will be described below as an example. FIG. 2 is a schematic cross-sectional view showing the structure of the electrode device of a laminated type secondary battery using a laminate film for a package. This electrode device is formed in such a manner that a plurality of positive electrodes c and a plurality of negative electrodes a are alternately stacked with separators b sandwiched therebetween. The positive electrode current collectors e of the positive electrodes c are welded and electrically connected to each other at the ends not covered with the positive electrode active material, and further, a positive electrode terminal f is welded to the welded part. The negative electrode current collectors d of the negative electrodes a are welded and electrically connected to each other at the ends not covered with the negative electrode active material, and further, a negative electrode terminal g is welded to the welded part.

### EXAMPLES

Specific Examples according to the exemplary embodiment of the present invention will be described below, but the exemplary embodiment of the present invention is not limited to these Examples.

### Example 1

### Fabrication of Negative Electrode

n-Methylpyrrolidone (NMP) and a polyamic acid (trade name: “U-VARNISH A,” Ube Industries, Ltd.) were mixed, and 10 μm thick copper foil was coated with the mixture by a doctor blade, and then, the coated copper foil was heated at 110° C. for 7 minutes to dry the NMP. Then, the coated copper foil was heated at 120° C. for 8 hours under a nitrogen atmosphere using an electric furnace to move the copper to the polyamic acid. Then, the electric furnace was heated at 350° C. for 30 minutes under a nitrogen atmosphere to cure the polyamic acid to form a conductive intermediate layer.

The thickness of the obtained conductive intermediate layer was about 1 μm.

The content (% by weight) of the conductive metal particles (copper particles) in the conductive intermediate layer was measured using D-SIMS (apparatus used: PHI ADEPT-1010 manufactured by ULVAC-PHI, Incorporated.). The content of the copper particles in the conductive intermediate layer was 66.3% by weight.

The content (% by volume) of the conductive metal particles (copper particles) in the conductive intermediate layer was calculated from the true density and % by weight of copper and U-VARNISH A after being cured.

The average particle diameter (D₅₀, volume basis) of the conductive metal particles (copper particles) in the conductive intermediate layer was obtained by analyzing a cross-sectional image obtained by an electron microscope. For the analysis, LUZEX AP manufactured by NIRECO CORPORATION was used. The measurement parameters were adjusted by previously measuring a standard sample (3020A (20 nm±2 nm)) from Thermo Fisher Scientific K.K.

SiO (trade name: “SIO05PB,” Kojundo Chemical Laboratory Co., Ltd.), carbon black (trade name: “#3030B,” manufactured by Mitsubishi Chemical Corporation), and a polyamic acid (trade name: “U-VARNISH A,” manufactured by Ube Industries, Ltd.) were measured at a mass ratio of 80:5:15. The SiO was adjusted using a sieve so that the average particle diameter D₅₀ was 25 μm. These and n-methylpyrrolidone (NMP) were mixed using a homogenizer to form a slurry. The mass ratio of the NMP to the solids was 57:43. The conductive intermediate layer was coated with the slurry using a doctor blade. Then, the coated material was heated at 120° C. for 7 minutes to dry the NMP. Then, the coated material was heated at 350° C. for 30 minutes under a nitrogen atmosphere using an electric furnace to fabricate a negative electrode.

(Fabrication of Positive Electrode)

Lithium cobaltate (manufactured by Nichia Corporation), carbon black (trade name:

“#3030B,” manufactured by Mitsubishi Chemical Corporation), and polyvinylidene fluoride (trade name: “#2400,” manufactured by KUREHA CORPORATION) were measured at a mass ratio of 95:2:3. These and NMP were mixed to form a slurry. The mass ratio of the NMP to the solids was 52:48. 15 μm thick aluminum foil was coated with the slurry using a doctor blade. The aluminum foil coated with the slurry was heated at 120° C. for 5 minutes to dry the NMP to fabricate a positive electrode.

(Assembly of Secondary Battery)

An aluminum terminal and a nickel terminal were welded to the fabricated positive electrode and negative electrode, respectively. These were superimposed on each other via a separator to fabricate an electrode device. The mass of the positive electrode and the negative electrode was adjusted so that the amount of lithium with which SiO, the negative electrode active material, was doped was any value during a fully charged state. A nickel terminal was welded to a reference electrode obtained by bonding copper foil to lithium metal, and the reference electrode was superimposed on the negative electrode via a separator. The electrode device and the reference electrode were packaged with a laminate film, and an electrolytic solution was injected inside the laminate film. Then, while the pressure inside the laminate film was reduced, the laminate film was heat-sealed and sealed. Thus, a flat plate type secondary battery before initial charge was fabricated. For the separator, a polypropylene film was used. For the laminate film, a polypropylene film on which aluminum was vapor-deposited was used. For the electrolytic solution, a solution comprising 1.0 mol/l of LiPF₆ as an electrolyte and a mixed solvent of ethylene carbonate and diethyl carbonate (7:3 (volume ratio)) as a nonaqueous electrolytic solvent was used.

(Charge and Discharge Cycle Test of Secondary Battery)

A charge and discharge cycle test was performed on the fabricated secondary battery in the battery voltage range of 2.5 to 4.2 V. The charge was performed by a CCCV method, and after 4.2 V was reached, the voltage was kept constant for 1 hour. The discharge was performed by a CC method (constant current 0.2 C). Here, 0.2 C current means a current at which when a battery in a fully charged state is subjected to constant current discharge, complete discharge of the battery takes 5 hours.

(Discharge Rate Test of Secondary Battery after Cycles)

After 100 cycles of the above-described charge and discharge cycle test was performed, a discharge rate test was performed. In the discharge rate test, the battery, in a fully charged state, was discharged at a constant current of 0.2 C or 3 C, the discharge capacity was measured, and the ratio of the discharge capacity (3 C/0.2 C) was calculated. Here, 3 C current means the current at which, when a battery in a fully charged state is subjected to constant current discharge, complete discharge of the battery takes 20 minutes.

### Example 2

A battery was fabricated and evaluated as in Example 1 except that the heating time at 120° C. during the fabrication of the conductive intermediate layer was changed to 12 hours.

### Example 3

A battery was fabricated and evaluated as in Example 1 except that the heating time at 120° C. during the fabrication of the conductive intermediate layer was changed to 16 hours.

### Example 4

A battery was fabricated and evaluated as in Example 1 except that the heating time at 120° C. during the fabrication of the conductive intermediate layer was changed to 24 hours.

### Reference Example 1

A battery was fabricated and evaluated as in Example 1 except that the heating time at 120° C. during the fabrication of the conductive intermediate layer was changed to 1 hour.

### Reference Example 2

A battery was fabricated and evaluated as in Example 1 except that the heating time at 120° C. during the fabrication of the conductive intermediate layer was changed to 3 hours.

### Reference Example 3

A battery was fabricated and evaluated as in Example 1 except that the heating time at 120° C. during the fabrication of the conductive intermediate layer was changed to 5 hours.

### Comparative Example 1

A battery was fabricated and evaluated as in Example 1 except that the conductive intermediate layer was not fabricated, and the active material layer was formed directly on the copper foil.

### Comparative Example 2

A battery was fabricated and evaluated as in Example 1 except that a negative electrode fabricated as follows was used.

n-Methylpyrrolidone (NMP), a polyamic acid (trade name: “U-VARNISH A,” Ube Industries, Ltd.), and copper particles (D₅₀: 300 nm) were mixed, and 10 μm thick copper foil was coated with the mixture by a doctor blade, and then, the coated copper foil was heated at 110° C. for 7 minutes to dry the NMP. Then, an electric furnace was heated at 350° C. for 30 minutes under a nitrogen atmosphere to cure the polyamic acid to form a polyimide layer comprising copper particles.

SiO (trade name: “SIO05PB,” Kojundo Chemical Laboratory Co., Ltd.), carbon black (trade name: “#3030B,” manufactured by Mitsubishi Chemical Corporation), and a polyamic acid (trade name: “U-VARNISH A,” manufactured by Ube Industries, Ltd.) were measured at a mass ratio of 80:5:15. The SiO was adjusted using a sieve so that the average particle diameter D₅₀ was 25 μm. These and n-methylpyrrolidone (NMP) were mixed using a homogenizer to form a slurry. The mass ratio of the NMP to the solids was 57:43. The above polyimide layer comprising copper particles was coated with the slurry using a doctor blade. Then, the coated material was heated at 120° C. for 7 minutes to dry the NMP. Then, the coated material was heated at 350° C. for 30 minutes under a nitrogen atmosphere using an electric furnace to fabricate a negative electrode.

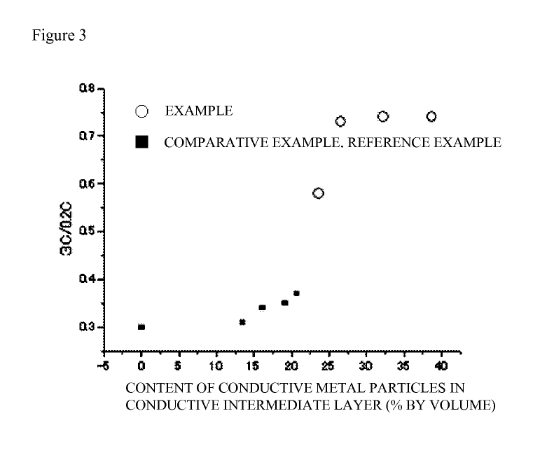

The evaluation results are shown in Table 1 and FIG. 3.

TABLE 1

| | | | Average particle | Content of conductive metal | Content of conductive metal | |
|---|---|---|---|---|---|---|
| | Negative | Heating time | diameter of conductive | particles in conductive | particles in conductive | 3 C/0.2 C |
| | electrode | during migration | metal particles | intermediate layer | intermediate layer | (after 100 |
| | active material | (hour) | (nm) | (% by volume) | (% by weight) | cycles) |
| Comparative | SiO | — | — | — | — | 0.30 |
| Example 1 | | | | | | |
| Comparative | SiO | — | 300 | 13.5 | 50.0 | 0.31 |
| Example 2 | | | | | | |
| Reference | SiO | 1 | 3 | 16.1 | 55.0 | 0.34 |
| Example 1 | | | | | | |
| Reference | SiO | 3 | 5 | 19.2 | 60.3 | 0.35 |
| Example 2 | | | | | | |
| Reference | SiO | 5 | 7 | 20.7 | 62.5 | 0.37 |
| Example 3 | | | | | | |
| Example 1 | SiO | 8 | 9 | 23.6 | 66.3 | 0.58 |
| Example 2 | SiO | 12 | 10 | 26.6 | 69.8 | 0.73 |
| Example 3 | SiO | 16 | 12 | 32.2 | 75.2 | 0.74 |
| Example 4 | SiO | 24 | 20 | 38.7 | 80.1 | 0.74 |

As shown in Table 1, in Examples 1 to 4 in which the content of the copper particles in the conductive intermediate layer was 23% by volume or more, the discharge capacity ratio (3 C/0.2 C) was high. The reason for this is presumed to be that when the content of the conductive particles in the conductive intermediate layer was 23% by volume or more, conductive paths of the conductive metal particles were formed in the conductive intermediate layer, and the conductivity increased.

In addition, the negative electrode for a lithium secondary battery in the exemplary embodiment of the present invention can also be grasped as follows.

(Supplementary Note 1)

A negative electrode for a lithium secondary battery comprising a current collector comprising a metal, and an active material layer comprising an active material and a binding agent wherein,

the negative electrode has a conductive intermediate layer comprising: conductive metal particles comprising the same element as the metal, and a polyimide or a polyamideimide, between the current collector and the active material layer, and

an average particle diameter of the conductive metal particles is 50 nm or less.

(Supplementary Note 2)

The negative electrode for a lithium secondary battery according to supplementary note 1, wherein a content of the conductive metal particles in the conductive intermediate layer is 23% by volume or more and 70% by volume or less.

(Supplementary Note 3)

The negative electrode for a lithium secondary battery according to supplementary note 1 or 2, wherein the content of the conductive metal particles in the conductive intermediate layer is 26% by volume or more and 50% by volume or less.

(Supplementary Note 4)

The negative electrode for a lithium secondary battery according to any of supplementary notes 1 to 3, wherein the metal is a metal soluble in a polyamic acid that is a precursor of the polyimide or the polyamideimide.

(Supplementary Note 5)

The negative electrode for a lithium secondary battery according to any of supplementary notes 1 to 4, wherein the metal is a metal not forming an alloy with Li in a potential range of 0 to 4.5 V (Li/Li⁺).

(Supplementary Note 6)

The negative electrode for a lithium secondary battery according to any of supplementary notes 1 to 5, wherein the conductive metal particles are formed by movement of the metal included in the current collector to a polyamic acid that is a precursor of the polyimide or the polyimideamide by migration phenomenon.

(Supplementary Note 7)

The negative electrode for a lithium secondary battery according to supplementary note 6, wherein the migration phenomenon is caused by placing the polyamic acid on the current collector and then performing heat treatment under a condition in which the temperature is lower than the imidization temperature of the polyamic acid.

(Supplementary Note 8)

The negative electrode for a lithium secondary battery according to any of supplementary notes 1 to 7, wherein the metal is at least one selected from copper, nickel, and silver.

(Supplementary Note 9)

The negative electrode for a lithium secondary battery according to any of supplementary notes 1 to 8, wherein the active material comprises at least one selected from Si and Sn.

(Supplementary Note 10)

The negative electrode for a lithium secondary battery according to any of supplementary notes 1 to 9, wherein the binding agent is a polyimide or a polyamideimide.

(Supplementary Note 11)

A lithium secondary battery comprising the negative electrode for a lithium secondary battery according to any of supplementary notes 1 to 10.

This application claims priority of Japanese Patent Application No. 2012-28147 filed Feb. 13, 2012, the entire disclosure of which is incorporated herein.

The invention of this application has been described with reference to the exemplary embodiments and the Examples, but the invention of this application is not limited to the above exemplary embodiments and Examples. Various changes that can be understood by those skilled in the art can be made in the configuration and details of the invention of this application within the scope of the invention of this application.

### REFERENCE SIGNS LIST

1 current collector
2 conductive intermediate layer
3 conductive metal particles
4 active material layer

1. A negative electrode for a lithium secondary battery, comprising: a current collector comprising a metal, and an active material layer comprising an active material and a binding agent, wherein
the negative electrode has a conductive intermediate layer comprising conductive metal particles comprising the same element as the metal, and a polyimide or a polyamideimide, between the current collector and the active material layer, and
a content of the conductive metal particles in the conductive intermediate layer is 23% by volume or more and 70% by volume or less.

2. The negative electrode for a lithium secondary battery according to claim 1, wherein the content of the conductive metal particles in the conductive intermediate layer is 26% by volume or more and 50% by volume or less.

3. The negative electrode for a lithium secondary battery according to claim 1, wherein an average particle diameter of the conductive metal particles is 50 nm or less.

4. The negative electrode for a lithium secondary battery according to claim 1, wherein the metal dissolves in a polyamic acid that is a precursor of the polyimide or the polyamideimide.

5. The negative electrode for a lithium secondary battery according to claim 1, wherein the metal does not form an alloy with Li in a potential range of 0 to 4.5 V (Li/Li⁺).

6. The negative electrode for a lithium secondary battery according to claim 1, wherein the conductive metal particles are formed by movement of the metal included in the current collector to a polyamic acid that is a precursor of the polyimide or the polyamideimide by migration phenomenon.

7. The negative electrode for a lithium secondary battery according to claim 6, wherein the migration phenomenon is caused by placing the polyamic acid on the current collector and then performing heat treatment under a condition in which the temperature is lower than the imidization temperature of the polyamic acid.

8. The negative electrode for a lithium secondary battery according to claim 1, wherein the metal is at least one selected from copper, nickel, and silver.

9. The negative electrode for a lithium secondary battery according to claim 1, wherein the active material comprises at least one selected from Si and Sn.

10. The negative electrode for a lithium secondary battery according to claim 1, wherein the binding agent is a polyimide or a polyamideimide.

11. A lithium secondary battery comprising the negative electrode for a lithium secondary battery according to claim 1.

12. A method for manufacturing a negative electrode for a lithium secondary battery comprising a current collector comprising a metal, an active material layer comprising an active material and a binding agent, and a conductive intermediate layer comprising conductive metal particles between the current collector and the active material layer, comprising steps of:
(1) placing a polyamic acid on the current collector;
(2) causing the metal to move from the current collector into the polyamic acid by generating migration phenomenon; and
(3) heating and curing the polyamic acid, in this order, wherein
the metal that has moved into the polyamic acid forms the conductive metal particles.

13. The method for manufacturing a negative electrode for a lithium secondary battery according to claim 12, wherein the migration phenomenon is caused by performing heat treatment under a condition in which the temperature is lower than the imidization temperature of the polyamic acid.

14. The method for manufacturing a negative electrode for a lithium secondary battery according to claim 13, wherein a temperature of the heat treatment is in a range of 80 to 150° C.

15. The method for manufacturing a negative electrode for a lithium secondary battery according to claim 12, wherein the polyamic acid comprises an organic acid.

16. The method for manufacturing a negative electrode for a lithium secondary battery according to claim 15, wherein the organic acid is phthalic acid, oxalic acid, or maleic acid.

17. The method for manufacturing a negative electrode for a lithium secondary battery according to claim 12, wherein a content of the conductive metal particles is 23% by volume or more and 70% by volume or less in the conductive intermediate layer.

18. The method for manufacturing a negative electrode for a lithium secondary battery according to claim 12, wherein the content of the conductive metal particles is 26% by volume or more and 50% by volume or less in the conductive intermediate layer.

19. The method for manufacturing a negative electrode for a lithium secondary battery according to claim 12, wherein an average particle diameter of the conductive metal particles is 50 nm or less.

20. The method for manufacturing a negative electrode for a lithium secondary battery according to claim 12, wherein the metal dissolves in the polyamic acid.

21. The method for manufacturing a negative electrode for a lithium secondary battery according to claim 12, wherein the metal does not form an alloy with Li in a potential range of 0 to 4.5 V (Li/Li⁺).

22. (canceled)

23. (canceled)

24. (canceled)
